(19) United States
(12) Patent Application Publication
(10) Pub. No.: US 2008/0215502 A1
(43) Pub. Date: Sep. 4, 2008

(54) METHOD OF PROVIDING A LIFE, VACATION, AND INVESTMENT POLICY

(76) Inventor: Daniel P. Sabbia, Zuerich (CH)

Correspondence Address: HAMMER & ASSOCIATES, P.C., 3125 SPRINGBANK LANE, SUITE G, CHARLOTTE, NC, 28226, US

(21) Appl. No.: 12/022,709

(22) Filed: Jan. 30, 2008

Related U.S. Application Data
(60) Provisional application No. 60/887,211, filed on Jan. 30, 2007.

(51) Int. Cl. G06Q 40/00

(52) U.S. Cl. 705/36 R

(57) ABSTRACT

A method of providing a life, vacation, and investment policy includes the steps of: creating a publicly traded securitized real estate corporation; providing a life, vacation, and investment policy through the corporation; securing the life, vacation, and investment policy through a bank note; and distributing the life, vacation, and investment policy to consumers through a third party. The life, vacation, and investment policy has benefits that include a vacation bonus. The vacation bonus is a contract for vacationing at the properties of the securitized real estate corporation. The life, vacation, and investment policy has investments that include: securitized real estates; and alternative investments.

### RELATED APPLICATION

This application claims the benefit of co-pending U.S. provisional patent application Ser. No. 60/887,211 filed Jan. 30, 2007.

### FIELD OF INVENTION

The present application discloses a method of providing a life, vacation, and investment policy through a publicly traded securitized Real Estate Corporation.

### BACKGROUND OF THE INVENTION

The securitized real estate business, in general, has averaged an annual growth rate of 10%. As a result, the internal rate of return of a public securitized real estate corporation may be much higher while having a very low debt rate. High demand vacation destinations, especially in emerging markets such as Costa Rica, Panama, and China, have a tremendous demand for luxury accommodations, while the supply may be extremely short. Therefore, the room shortages for the luxury traveler offer higher occupancy and room rates, leading to appreciating assets based on an attractive cash flow generated from satisfying the country's room shortage. These factors have a tremendous impact on the properties valuation, as determined by room rate, occupancy rates, cash flow and return on assets valuation models, as well as on land prices.

A Real Estate Investment Trust, or REIT, is a tax designation for a corporation investing in real estate that reduces or eliminates corporate income taxes. In return, a REIT is required to distribute 90% of its income, which may be taxable in the hands of the investors. The REIT structure was designed to provide a similar structure for investment in real estate as mutual funds provide for investment in stocks. Like other corporations, a REIT can be publicly or privately held. A public REIT may be listed on public stock exchanges like shares of common stock in other firms and can be classified as equity, mortgage or hybrid.

Although a REIT can be very profitable due to real estate profits, a REIT has to pay high dividends by allocating profits towards internal growth. Thus, there is a need for a corporate structure that is similar to a REIT in that it is funded through real estate investments, but is dissimilar in that it does not have to pay high dividends by allocating profits towards internal growth. The instant invention of a method of providing a life, vacation, and investment policy may be designed to address the aforementioned problems.

### SUMMARY OF THE INVENTION

The instant invention is directed toward a method of providing a life, vacation, and investment policy. The method may include the following steps: creating a publicly traded securitized real estate corporation; providing a life, vacation, and investment policy through the corporation; securing the life, vacation and investment policy through a bank note; and distributing the life, vacation, and investment policy to consumers through a third party. The life, vacation, and investment policy may have benefits that may include a vacation bonus. The vacation bonus may be a contract for vacationing at the properties of the securitized real estate corporation. The life, vacation, and investment policy may have investments that may include: securitized real estates; and alternative investments.

### DETAILED DESCRIPTION OF THE INVENTION

The current invention may be a method of providing a life, vacation, and investment policy through a publicly traded securitized Real Estate Corporation. The method may include the steps of: creating a publicly traded securitized real estate corporation; providing a life, vacation and investment policy through the corporation; securing the life, vacation and investment policy through a bank note; and distributing the life, vacation, and investment policy to consumers through a third party. The life, vacation, and investment policy may be a value added policy (capital protected policy) that may include a value added vacation bonus and a universal life and/or investment policy. The value added policy may be viewed as a universal life/investment policy that includes a vacation bonus.

The public securitized real estate corporation may own and operate income generating real estate, similar to an exchange traded REIT (Real Estate Investment Trusts). However, the public securitized real estate corporation may not have to pay high dividends by allocating profits towards internal growth. The securitized real estate business, in general, has averaged an annual growth rate of 10%. As a result, the internal rate of return of the public securitized real estate corporation may be much higher while having a very low debt rate.

The publicly traded securitized real estate corporation may focus primarily on the selection of prime properties in high demand vacation destinations around the world as well as the building of luxury accommodations in those areas. The corporation's goal may be to build accommodations which vary from luxury apartments/condominiums with the possibility of integrated accommodations for service personnel (maid, etc.), to luxury villas and residential clubs in the high end sector. As example, the accommodations may be equipped with first class amenities and be adjacent to large pools, restaurants, bars, and beaches. The aim of the corporation may be to locate first class accommodations in highly desirable locations with numerous activities within the vicinity such as, golfing, spa, shopping, fishing, fine dining, horse back riding etc., while still being affordable to the middle and upper class market.

High demand vacation destinations, especially in emerging markets such as Costa Rica, Panama, and China, have a tremendous demand for luxury accommodations, while the supply may be extremely short. Therefore, the room shortages for the luxury traveler offer higher occupancy and room rates, leading to appreciating assets based on an attractive cash flow generated from satisfying the country's room shortage. These factors have a tremendous impact on the properties valuation, as determined by room rate, occupancy rates, cash flow and return on assets valuation models, as well as on land prices. These issues may be mirrored in the corporation's appreciation and revenues structure, thus, driving internal growth of the publicly traded securitized real estate corporation.

The life, vacation, and investment policy may be offered through third parties. These third parties may include, but are not limited to: large broker dealer firms, mid sized broker dealer firms, insurance brokers, real estate agents, financial planners, site marketing campaigns, and in flight magazines of airlines flying to destinations where said corporation owns property. The policy may give the consumer an indirect ownership (preferred shares) in the publicly traded securitized real estate corporation. This enables the consumer to invest in the publicly traded securitized real estate corporation, i.e., the consumer may be an indirect real estate co-owner at a global level.

The ownership in the life, vacation and investment policy may include the benefit of a universal life investment policy. The universal life investment policy may be a universal life insurance policy, annuity, or a variable insurance policy, that includes a vacation bonus. The universal life investment policy may also or alternatively include such things as a 401k type investment policy and/or a 1031 exchange type investment policy. The policies may be invested through securitized real estates, alternative investment models, and/or zero coupon bonds, which may include life settlement policies. The life settlement policies may allow the life insurance aspect of the policy to mature in 25 years.

The vacation bonus may be a contract to luxury vacationing for a minimum of 7 nights per year (or more depending on season and investment size) in the accommodations owned and operated by the publicly traded securitized real estate corporation.

The life, vacation, and investment policy may be invested into four types of investments. One part (up to 35%) may be invested in an alternative investment model. The other part (up to 65%) flows into the publicly traded securitized real estate corporation, which based on forecasts, may grow proportionally with the increase of policy sales, meaning, the more money that flows into the corporation, the more assets that may be generated. Accordingly, the policy's value should increase proportionally with the sales volumes of the policy based on an asset valuation or cash flow projected basis. Thus, the policy may bear a capital guarantee as well as the benefit of the dynamic increase of the company's assets and of the dynamics of the funds under management.

The overall investment in the bank note by a consumer may be a capital protected investment model designed to have a minimum risk exposure of 3.5% per annum and a performance potential between 6 to 9% per annum. The whole investment, such as a zero coupon bond, preferred convertible shares, as well as the alternative investment, may be secured (wrapped) by the bank note. The total investment model may be secured in a bank note from a quotable financial instrument such as double AA S&P rated bank, like in a hedge fund, a mutual fund, an annuity, any 401k type investment, and/or any 1031 exchange type investment. The alternative investment model may include the life settlement policies (9%). The bank note may have a Cusip Number for allowing the life, vacation, and investment policy to be electronically transferred into managed accounts.

The alternative investments may or may not include investing in zero coupon bonds. The zero coupon bonds may have a 25 year maturity period. If zero coupon bonds are attached to the policy then the costs of the zero coupon bonds would be deducted from the alternative investments. The zero coupon bond may be to secure the bank note for the preferred convertible shares. The bank note (it could also be a note in a hedge fund, mutual fund, etc.) may be designed to facilitate the insurance in order for them to have a paper which may be quoted, since most of the time the laws require them to purchase only quoted papers.

The liquidation of the investors' shares gives the greatest return on investment for the consumer/shareholder. Thus, the publicly traded securitized real estate corporation may offer a share buy back program to policy owners in reasonable intervals to offer the investors liquidity with minimal impact on the market price. In sum, the policy combines the benefits of an Exchange Traded Fund and the benefit of Real Estate Investment Funds, while minimizing their downsides.

The method of providing a life, vacation, and investment policy may comprise the steps of: creating a publicly traded securitized real estate corporation; providing a life, vacation, and investment policy through the corporation; securing the life, vacation, and investment policy through a bank note; and distributing the life, vacation and investment policy through third parties. The bank note may have a Cusip Number for allowing the life, vacation, and investment policy to be electronically transferred into managed accounts. The policy may be distributed through third parties selected from the group consisting of: large broker dealer firms, mid sized broker dealer firms, insurance brokers, real estate agents, financial planners, site marketing campaigns, and in flight magazines of airlines flying to destinations where said corporation owns property. The life, vacation, and investment policy may have benefits including, but not limited to, a universal life insurance policy, an annuity, a hedge fund, a mutual fund, a 401k type investment policy, a 1031 exchange type investment policy, and a vacation bonus. The vacation bonus may be a contract for vacationing at the properties of the securitized real estate corporation. The contract may be for a minimum of 7 days a year for 25 years. The life, vacation, and investment policy may have investments that include, but are not limited to, securitized real estates, and alternative investments. The securitized real estates may be 65% of the investments. The securitized real estates may be preferred convertible shares of the securitized real estate corporation. The preferred convertible shares may include a share buy back program that may be adapted for making the preferred convertible shares liquid. The alternative investments may be 35% of the investments. The alternative investments may include an investment model that may have low correlation to the stock markets and may have a maximum risk exposure of 3.5% per annum. The alternative investment model may have a performance potential between 6 to 9% per annum. The investment model may be 24% of the alternative investments. The alternative investments may include zero coupon bonds. The zero coupon bonds may have a 25 year maturity period.

### Example Policy Description

$18,900 received at the minimum:

1. 17% commissions, $2,457
a. 5 year liquidation intervals, if sold before 5 years loose 17%
b. Every 5 years they receive cash back. They must convert those shares for the cash. After 25 years they receive 50% of funds plus maturity of zero coupon bonds of 100 percent.

2. Remaining 83% becomes 100% $16,443 ($18,900−$2,457)
a. 35% goes to non stock related investments $5,755 (16,443×35%)
   i. 3-5% insurance policy umbrella premium $658 (16,443×4%)
   ii. Zero Coupon Bonds $5,097 ($5,755−$658)
b. 65% goes to stock investments $10,688 ($16,443−$5,755)
   i. Real Estate backed preferred shares convertible every 5 years
      1. Land cost<=units available×48=room key price of $513,024 (10,688×48)

3. Real Estate Project Owned: As funds arrive we retire the specific real estate subsidiary's preferred shares and issue cash payments substituting the shareholders preferred shares with the land owners preferred shares.

4. Property Management
a. Each property will be prepaid before guest arrives.
b. On site management whose job will be to optimize the clients stay while providing numerous ways for the quest to spend funds.
c. All units will be convertible to condo's or home sales.
d. Commissionable events for excursions.
e. In the event of an economic downturn, each properties inventory can be liquidated as a planned community.

The present invention may be embodied in other forms without departing from the spirit and the essential attributes thereof, and, accordingly, reference should be made to the appended claims, rather than to the foregoing specification, as indicated in the scope of the invention.

I claim:

1. A method of providing a life, vacation, and investment policy comprising the steps of:
creating a publicly traded securitized real estate corporation;
providing a life, vacation, and investment policy through said corporation;
securing said life, vacation, and investment policy through a bank note; and
distributing said life, vacation, and investment policy to consumers through a third party;
said life, vacation, and investment policy having benefits comprising:
a vacation bonus being a contract for vacationing at the properties of said securitized real estate corporation;
said life, vacation, and investment policy having investments comprising:
securitized real estates; and
alternative investments.

2. The method of providing a life, vacation, and investment policy of claim 1 where said benefits including a universal life insurance policy, where said alternative investments including life settlement policies.

3. The method of providing a life, vacation, and investment policy of claim 2 where said life insurance policy maturing in 25 years.

4. The method of providing a life, vacation, and investment policy of claim 2 where said life settlement policies being 9% of said investments.

5. The method of providing a life, vacation, and investment policy of claim 1 where said benefits including a 401k type investment policy.

6. The method of providing a life, vacation, and investment policy of claim 1 where said benefits including a 1031 exchange type investment policy.

7. The method of providing a life, vacation, and investment policy of claim 1 where said third parties being selected from the group consisting of: large broker dealer firms, mid sized broker dealer firms, insurance brokers, real estate agents, financial planners, site marketing campaigns, and in flight magazines of airlines flying to destinations where said corporation owns property.

8. The method of providing a life, vacation, and investment policy of claim 1 where said contract for vacationing at the properties of said corporation being for a minimum of 7 days a year for 25 years.

9. The method of providing a life, vacation, and investment policy of claim 1 where said securitized real estates being preferred convertible shares of said securitized real estate corporation.

10. The method of providing a life, vacation, and investment policy of claim 9 where said preferred convertible shares of said securitized real estate corporation include a share buy back program adapted for making said preferred convertible shares liquid.

11. The method of providing a life, vacation, and investment policy of claim 1 where said securitized real estates being 65% of said investments.

12. The method of providing a life, vacation, and investment policy of claim 1 where said alternative investments being 35% of said investments and including an investment model having low correlation to the stock markets.

13. The method of providing a life, vacation, and investment policy of claim 12 where said investment model having a maximum risk exposure of 3.5% per annum and having a performance potential between 6 to 9% per annum.

14. The method of providing a life, vacation, and investment policy of claim 12 where said investment model being 24% of said alternative investments.

15. The method of providing a life, vacation, and investment policy of claim 1 where said alternative investments including an investment from the group consisting of: a hedge fund, a mutual fund, and an annuity.

16. The method of providing a life, vacation, and investment policy of claim 1 where said bank note having a Cusip Number for allowing said life, vacation, and investment policy to be electronically transferred into managed accounts through said third parties.

17. The method of claim 1 where said life, vacation, and investment policy further comprising zero coupon bonds.

18. The method of providing a life, vacation, and investment policy of claim 17 where said zero coupon bonds having a 25 year maturity period.

19. The method of providing a life, vacation, and investment policy of claim 17 where said zero coupon bonds being deducted from said alternative investments.

20. A method of providing a life, vacation, and investment policy comprising the steps of:
creating a publicly traded securitized real estate corporation;
providing a life, vacation, and investment policy through said corporation;
securing said life, vacation, and investment policy through a bank note having a Cusip Number for allowing said life, vacation, and investment policy to be electronically transferred into managed accounts through third parties;
distributing said life, vacation and investment policy through third parties selected from the group consisting of: large broker dealer firms, mid sized broker dealer firms, insurance brokers, real estate agents, financial planners, site marketing campaigns, and in flight magazines of airlines flying to destinations where said corporation owns property;
said life, vacation, and investment policy having benefits comprising:
a universal life insurance policy;
an annuity;
a hedge fund;
a mutual fund;
a 401k type investment policy; and
a 1031 exchange type investment policy; and
a vacation bonus being a contract for vacationing at the properties of said securitized real estate corporation for a minimum of 7 days a year for 25 years;
said life, vacation, and investment policy having investments comprising:
securitized real estates being 65% of said investments and being preferred convertible shares of said securitized real estate corporation where said preferred convertible shares of said securitized real estate corporation include a share buy back program adapted for making said preferred convertible shares liquid; and
alternative investments being 35% of said investments and including an investment model having low correlation to the stock markets and having a maximum risk exposure of 3.5% per annum and having a performance potential between 6 to 9% per annum;
said investment model being 24% of said alternative investments including zero coupon bonds having a 25 year maturity period.
